(19) United States
(12) Patent Application Publication
(10) Pub. No.: US 2013/0095775 A1
(43) Pub. Date: Apr. 18, 2013

(54) FRONT END MODULE AND WIRELESS SIGNAL PROCESSING APPARATUS HAVING THE SAME

(71) Applicant: Nam Heung KIM, Suwon (KR)

(72) Inventor: Nam Heung KIM, Suwon (KR)

(73) Assignee: SAMSUNG ELECTRO-MECHANICS CO., LTD.

(21) Appl. No.: 13/618,459

(22) Filed: Sep. 14, 2012

(30) Foreign Application Priority Data
Oct. 14, 2011 (KR) 10-2011-0105228

(51) Int. Cl. H04B 1/40

(52) U.S. Cl. 455/84

(57) ABSTRACT

There are provided a front end module increasing power efficiency used at the time of transmitting and receiving a signal and a wireless signal processing apparatus having the same. The front end module includes: a matching unit matching impedance of a signal path of a signal transmitted and received through an antenna in accordance with a control signal; a signal processing unit receiving power to perform sinal processing on the signal transmitted and received through the antenna; and a controlling unit comparing a current level used by the signal processing unit so as to perform signal processing on the transmitted and received signal with a power level of the signal transmitted and received through the antenna to thereby control impedance matching of the matching unit in accordance with a result of the comparison.

### CROSS-REFERENCE TO RELATED APPLICATIONS

This application claims the priority of Korean Patent Application No. 10-2011-0105228 filed on Oct. 14, 2011, in the Korean Intellectual Property Office, the disclosure of which is incorporated herein by reference.

### BACKGROUND OF THE INVENTION

1. Field of the Invention

The present invention relates to a front end module increasing power efficiency, used at the time of transmitting and receiving a signal, and a wireless signal processing apparatus having the same.

2. Description of the Related Art

In recent years, wireless signal processing apparatuses including smart phones, personal digital assistants (PDA), and the like have been widely used due to convenience in portability, advantages in use, and the like.

The wireless signal processing apparatus primarily adopts a battery supplying driving power required for the apparatus in order to provide convenience in terms of portability, and has a limit on the time for which the battery can supply power.

The capacity of a battery may be increased in order to overcome this limitation, but an increase in the capacity of a battery results in a corresponding increase in volume and weight thereof, and as a result, the volume and the weight of the wireless signal processing apparatus may also be increased, such that a user's expectations may not be satisfied.

Meanwhile, the wireless signal processing apparatus primarily transmits and receives a signal by using an antenna. When the load of the antenna changes, impedance matched with the antenna varies, and as a result, a voltage standing wave ratio (VSWR) changes, thereby deteriorating antenna gain.

As a result, signal transmission/reception power efficiency deteriorates and thus, the use time of the battery decreases.

### SUMMARY OF THE INVENTION

An aspect of the present invention provides a front end module increasing power efficiency, used at the time of transmitting and receiving a signal, and a wireless signal processing apparatus having the same.

According to an aspect of the present invention, there is provided a front end module including: a matching unit matching impedance of a signal path of a signal transmitted and received through an antenna in accordance with a control signal; a signal processing unit receiving power to perform sinal processing on the signal transmitted and received through the antenna; and a controlling unit comparing a current level used by the signal processing unit so as to perform signal processing on the transmitted and received signal with a power level of the signal transmitted and received through the antenna to thereby control impedance matching of the matching unit in accordance with a result of the comparison.

The controlling unit may include: a detection part having a table storing a power level and a reference current level depending on the power level, detecting the power level of the signal transmitted and received through the antenna, and providing the reference current level depending on the detected power level; and a comparison part comparing the reference current level of the detection part with the current level used by the signal processing unit.

The signal processing unit may include: a front end part filtering and low noise-amplifying the transmitted and received signal; and an amplifying part amplifying the power level of the transmitted and received signal by a predetermined gain.

The matching unit may include an impedance varying part varying the impedance in accordance with the result of the comparison.

The impedance varying part may include: a first variable capacitor including one end and the other end thereof connected between a first terminal and a second terminal, between which the signal is transmitted and received, and having a capacitance varied in accordance with a first control voltage; a second variable capacitor including one end thereof connected to the other end of the first variable capacitor and the other end thereof connected to a ground, and having a capacitance varied in accordance with a second control voltage; a third variable capacitor including one end and the other end thereof connected between the other end of the first variable capacitor and the second terminal, and having a capacitance varied in accordance with a third control voltage; a first inductor including one end thereof connected to the other end of the first variable capacitor and one end of the third variable capacitor and the other end thereof connected to the ground; and a second inductor including one end thereof connected to the other end of the third variable capacitor and the other end thereof connected to the second terminal.

The matching unit may further include a digital-to-analog converter (DAC) supplying the first, second, and third control voltages to vary the capacitances of the first, second, and third variable capacitors in accordance with the control signal.

According to another aspect of the present invention, there is provided a wireless signal processing apparatus including: a front end module including a matching unit matching impedance of a signal path of a signal transmitted and received through an antenna in accordance with a control signal; a signal processing unit receiving power to perform sinal processing on the signal transmitted and received through the antenna; and a controlling unit comparing a current level used by the signal processing unit so as to perform signal processing on the transmitted and received signal with a power level of the signal transmitted and received through the antenna to thereby control impedance matching of the matching unit in accordance with a result of the comparison; and a baseband unit modulating a frequency of the signal transmitted to and received from the front end module.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic configuration diagram of a front end module according to an embodiment of the present invention;

FIG. 2 is a detailed configuration diagram of the front end module according to the embodiment of the present invention;

FIG. 3 is a graph illustrating an electrical characteristic between an impedance mismatch and current;

FIG. 4 is a circuit diagram of an impedance varying part adopted in the front end module according to the embodiment of the present invention; and

FIG. 5 is a schematic configuration diagram of a wireless signal processing apparatus according to another embodiment of the present invention.

### DETAILED DESCRIPTION OF THE INVENTION

Embodiments of the present invention will be described in detail with reference to the accompanying drawings. These embodiments will be described in detail for those skilled in the art in order to practice the present invention.

In describing exemplary embodiments of the present invention, well-known functions or constructions will not be described in detail since they may unnecessarily obscure the understanding of the present invention.

The similar reference numerals will be used to describe the same or similar functions throughout the accompanying drawing.

Throughout this specification and the claims that follow, when a component is mentioned as being “connected” to another component, this may mean that it is directly connected to the other component, but it is to be understood that another component may exist therebetween.

In addition, unless explicitly described to the contrary, the word “comprise” and variations such as “comprises” or “comprising”, will be understood to imply the inclusion of stated elements but not the exclusion of any other elements.

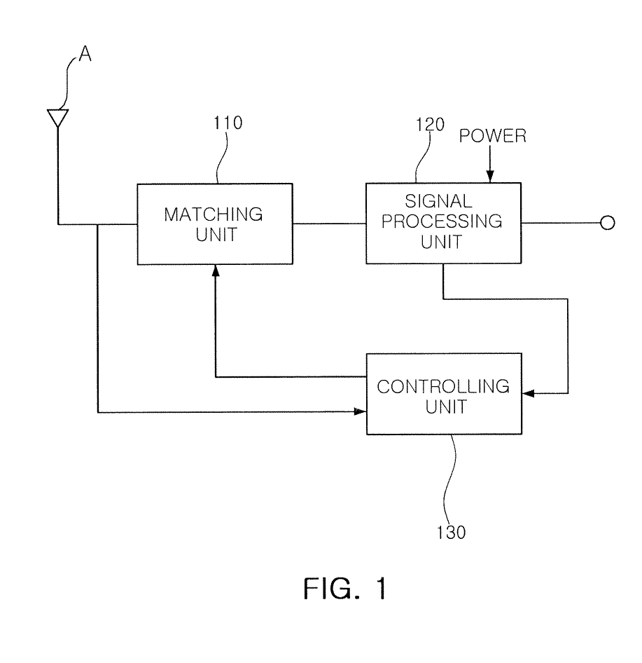

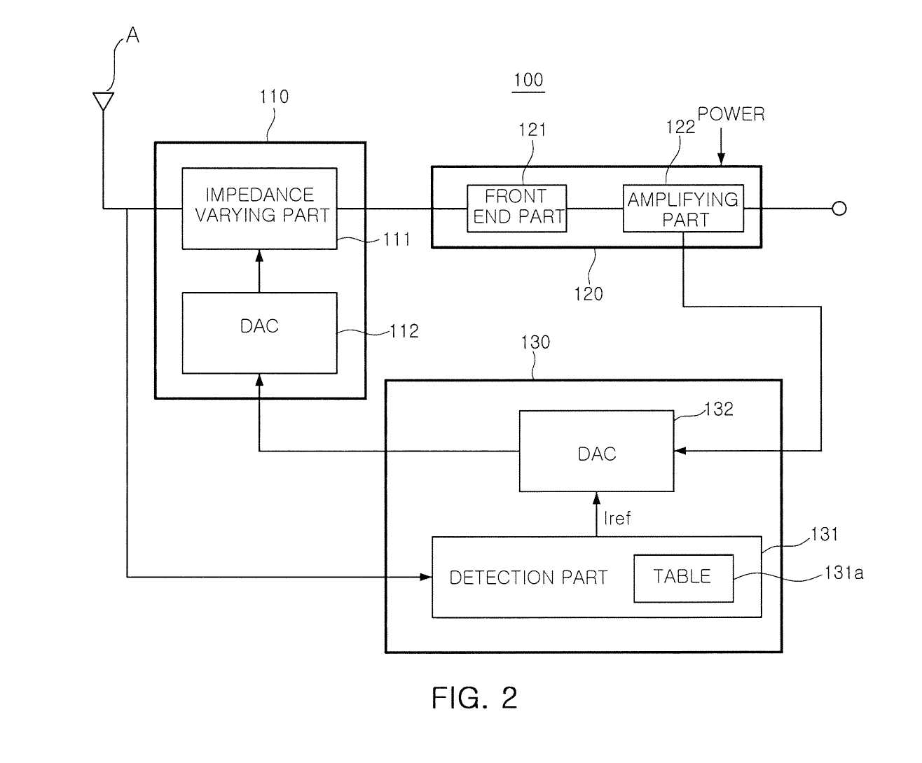

FIG. 1 is a schematic configuration diagram of a front end module according to an embodiment of the present invention and FIG. 2 is a detailed configuration diagram of the front end module according to the embodiment of the present invention.

First, referring to FIG. 1, a front end module 100 according to the embodiment of the present invention includes a matching unit 110, a signal processing unit 120, and a controlling unit 130.

The matching unit 110 may match impedance of a signal transmission path of a signal transmitted and received through an antenna A.

In this case, the matching unit 110 may vary the impedance according to a control signal of the controlling.

That is, referring to FIG. 2, the matching unit 110 may include an impedance varying part 111 and a digital-to-analog converter (DAC) 112.

The impedance varying part 111 may vary the impedance of the signal transmission path of the signal transmitted and received through the antenna A according to a control voltage of the DAC 112.

For example, when an output impedance of the signal processing unit 120 is maintained to be 50 ohm, high power efficiency may be obtained and to this end, the impedance of the signal transmission path in which the signal is transmitted and received through the antenna A may be maintained to be 50 ohm.

However, when a load of the antenna A varies, the impedance varies, and as a result, the impedance varying part 111 may vary the impedance of the signal transmission path of the signal transmitted and received through the antenna A according to the control voltage of the DAC 112.

The DAC 112 may supply the control voltage, in accordance with which, the impedance varying part 111 may vary the impedance according to the control signal of the controlling unit 130. That is, the control signal of the controlling unit 130 may be a digital signal. The digital signal is converted into the control voltage which is an analog signal to be provided to the impedance varying part 111.

The signal processing unit 120 may perform signal processing on the transmitted and received signal. Referring to FIG. 2, the signal processing unit 120 may include a front end part 121 and an amplifying part 122.

The front end part 121 may include a filter and a low noise amplifier. Accordingly, the transmitted and received signal may be filtered in a predetermined frequency band and amplified with low noise.

The amplifying part 122 may amplify the transmitted and received signal by a predetermined gain.

The signal processing unit 120 may receive power to perform a front end operation and an amplifying operation. The signal processing unit 120 may perform the front end operation and the amplifying operation by using the supplied power. In this case, current used in the signal processing unit 120 may be varied in accordance with a degree of impedance matching. That is, when the load of the antenna A varies, the impedance may be mismatched. However, since a power level of the signal transmitted and received through the antenna A needs to be consistently maintained according to a distance, the amount of the current used in the signal processing unit 120 may increase.

The controlling unit 130 may compare a current level used in the signal processing unit 120 with the power level of the signal transmitted and received through the antenna A to control the impedance variation of the matching unit 110 according to a result of the comparison.

To this end, the controlling unit 130 may include a detection part 131 and a comparison part 132.

The detection part 131 may detect the power level of the signal transmitted and received through the antenna A and include a table 131a therein.

The table 131a may store reference current Iref used by the signal processing unit 120 when the impedance is optimally matched according to the detected power level.

The power level of the signal transmitted and received through the antenna A may be maintained to be a predetermined strong electric field or weak electric field power level set according to a distance from a base station.

The comparison part 132 may compare the reference current Iref according to the detected power level with the current used in the signal processing unit 120. In this case, when there is no difference between the reference current Iref and the current used in the signal processing unit 120, the impedance is optimally matched. Accordingly, the impedance of the matching unit 110 may be controlled to be maintained. The comparison part 132 compare the reference current Iref according to the detected power level with the current used in the signal processing unit 120. In this case, when there is a difference therebetween, the impedance is mismatched. Accordingly, the impedance of the matching unit 110 may be controlled to be varied.

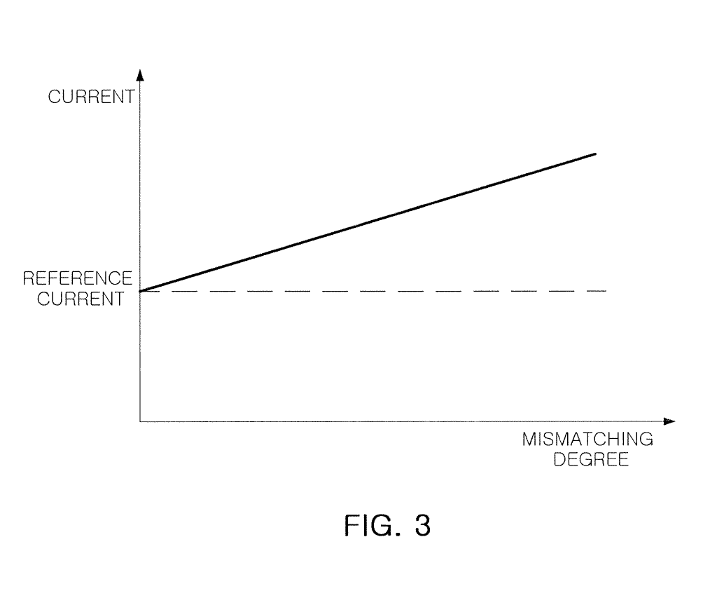

FIG. 3 is a graph illustrating an electrical characteristic between an impedance mismatch and current

Referring to FIG. 3, it can be seen that a difference between the reference current (dot line) and the current (solid line) used in the signal processing unit 120 may increased according to the degree of impedance mismatching, as described above.

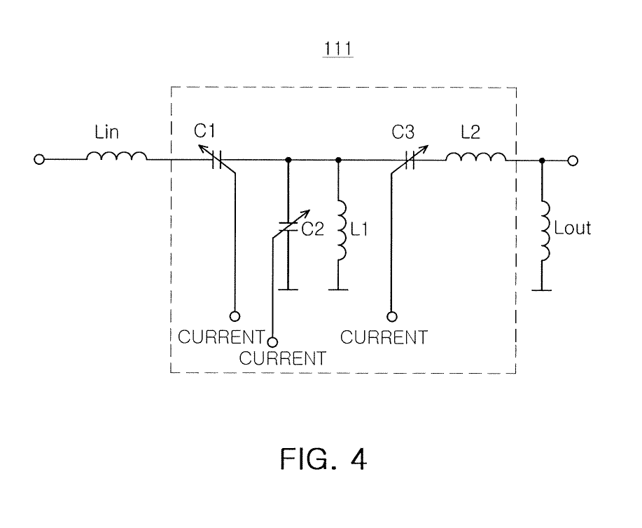

FIG. 4 is a circuit diagram of an impedance varying part adopted in the front end module according to the embodiment of the present invention.

Referring to FIG. 4, the impedance varying part 111 may include first to third variable capacitors C1, C2, and C3 and first and second inductors L1 and L2.

The first variable capacitor C1 may include one end and the other end, electrically connected between a first terminal and a second terminal, between which the signal is transmitted and received.

In the first variable capacitor C1, a capacitance may vary according to a first control voltage Va from the DAC 112.

One end of the second variable capacitor C2 may be electrically connected to the other end of the first variable capacitor C1 and the other end of the second variable capacitor C2 may be electrically connected to a ground.

Likewise, in the second variable capacitor C2, a capacitance may vary according to a second control voltage Vb from the DAC 112.

One end of the third variable capacitor C3 may be electrically connected to the other end of the first variable capacitor C1 and the other end of the third variable capacitor C3 may be electrically connected to the second terminal in which the signal is transmitted and received.

Likewise, in the third variable capacitor C3, a capacitance may vary according to a third control voltage Vc from the DAC 112.

One end of the first inductor L1 may be electrically connected to the other end of the first variable capacitor and one end of the third variable capacitor. The other end of the first inductor L1 may be electrically connected to the ground.

One end of the second inductor L2 may be electrically connected to the other end of the third variable capacitor C3 and the other end of the second inductor L2 may be electrically connected to the second terminal.

Inductances of the first and second inductors L1 and L2 are combined with the capacitances of the first to third variable capacitors C1, C2, and C3 to form impedance.

In this case, the capacitances of the first to third variable capacitors C1, C2, and C3 are varied by the first to third control voltages Va, Vb, and Vc, respectively to vary the impedance.

When the output impedance of the signal processing unit 120 is maintained to be 50 ohm, high power efficiency may be obtained. To this end, in order that input impedance Zi is also maintained to be 500 ohm, the capacitances of the first to third varying capacitances C1, C2, and C3 may be varied by the first to third control voltages Va, Vb, and Vc, respectively.

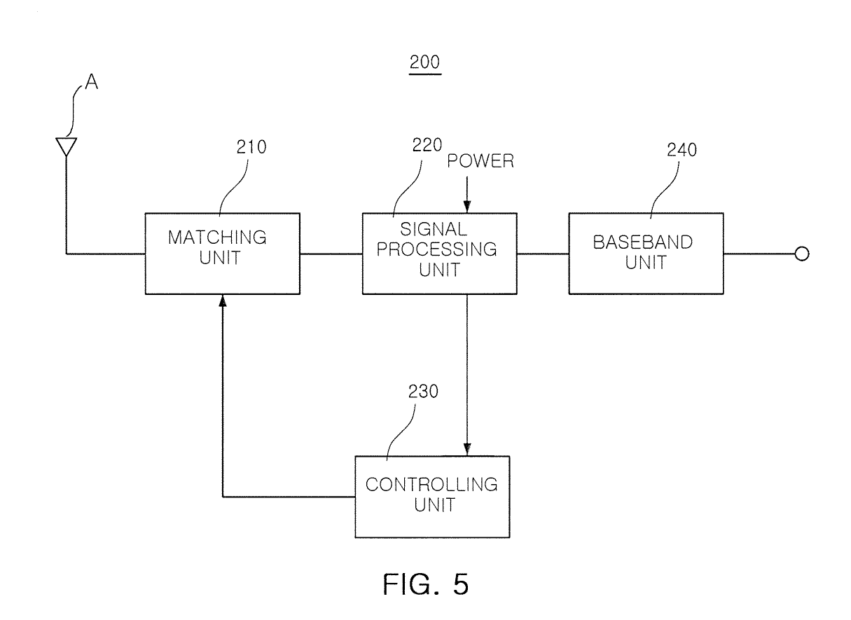

FIG. 5 is a schematic configuration diagram of a wireless signal processing apparatus according to another embodiment of the present invention.

Referring to FIG. 5, a wireless signal processing apparatus 200 according to the embodiment of the present invention may include a matching unit 210, a signal processing unit 220, a controlling unit 230, and a baseband unit 240.

Since the matching unit 210, the signal processing unit 220, and the controlling unit 230 may have the same configurations and operations as those of the matching unit 110, the signal processing unit 120, and the controlling unit 130 of the front end module 100 according to the foregoing embodiment of the present invention shown in FIGS. 1 and 2, a detailed description therefor will be omitted.

The baseband unit 240 may modulate a frequency of a signal transferred to the signal processing unit 220 or a signal transferred from the signal processing unit 220.

That is, the baseband unit 240 may modulate a baseband signal into a high-frequency or ultrahigh-frequency band signal to transfer the modulated signal to the signal processing unit 220, or modulate a signal from the signal processing unit 220 into a baseband signal.

As described above, according to the embodiments of the present invention, a power level of a signal transmitted and received through an antenna is compared with a current level used to process the transmitted and received signal and according to a result of the comparison, impedance of the antenna can be varied to increase power efficiency used at the time of transmitting and receiving the signal, thereby increasing the use time of a battery.

Furthermore, impedance variation of the antenna in a front end module can be controlled without a link between a baseband circuit and software, such that unnecessary current consumption can be low, a processing speed can be fast, and an unnecessary operation for linking software cannot be required.

While the present invention has been shown and described in connection with the embodiments, it will be apparent to those skilled in the art that modifications and variations can be made without departing from the spirit and scope of the invention as defined by the appended claims.

What is claimed is:

1. A front end module comprising:
a matching unit matching impedance of a signal path of a signal transmitted and received through an antenna in accordance with a control signal;
a signal processing unit receiving power to perform sinal processing on the signal transmitted and received through the antenna; and
a controlling unit comparing a current level used by the signal processing unit so as to perform signal processing on the transmitted and received signal with a power level of the signal transmitted and received through the antenna to thereby control impedance matching of the matching unit in accordance with a result of the comparison.

2. The front end module of claim 1, wherein the controlling unit includes:
a detection part having a table storing a power level and a reference current level depending on the power level, detecting the power level of the signal transmitted and received through the antenna, and providing the reference current level depending on the detected power level; and
a comparison part comparing the reference current level of the detection part with the current level used by the signal processing unit.

3. The front end module of claim 1, wherein the signal processing unit includes:
a front end part filtering and low noise-amplifying the transmitted and received signal; and
an amplifying part amplifying the power level of the transmitted and received signal by a predetermined gain.

4. The front end module of claim 1, wherein the matching unit includes an impedance varying part varying the impedance in accordance with the result of the comparison.

5. The front end module of claim 4, wherein the impedance varying part includes:
a first variable capacitor including one end and the other end thereof connected between a first terminal and a second terminal, between which the signal is transmitted and received, and having a capacitance varied in accordance with a first control voltage;
a second variable capacitor including one end thereof connected to the other end of the first variable capacitor and the other end thereof connected to a ground, and having a capacitance varied in accordance with a second control voltage;
a third variable capacitor including one end and the other end thereof connected between the other end of the first variable capacitor and the second terminal, and having a capacitance varied in accordance with a third control voltage;
a first inductor including one end thereof connected to the other end of the first variable capacitor and one end of the third variable capacitor and the other end thereof connected to the ground; and
a second inductor including one end thereof connected to the other end of the third variable capacitor and the other end thereof connected to the second terminal.

6. The front end module of claim 5, wherein the matching unit further includes a digital-to-analog converter (DAC) supplying the first, second, and third control voltages to vary the capacitances of the first, second, and third variable capacitors in accordance with the control signal.

7. A wireless signal processing apparatus comprising:
a front end module including a matching unit matching impedance of a signal path of a signal transmitted and received through an antenna in accordance with a control signal; a signal processing unit receiving power to perform sinal processing on the signal transmitted and received through the antenna; and a controlling unit comparing a current level used by the signal processing unit so as to perform signal processing on the transmitted and received signal with a power level of the signal transmitted and received through the antenna to thereby control impedance matching of the matching unit in accordance with a result of the comparison; and
a baseband unit modulating a frequency of the signal transmitted to and received from the front end module.

8. The wireless signal processing apparatus of claim wherein the controlling unit includes:
a detection part having a table storing a power level and a reference current level depending on the power level, detecting the power level of the signal transmitted and received through the antenna, and providing the reference current level depending on the detected power level; and
a comparison part comparing the reference current level of the detection part with the current level used by the signal processing unit.

9. The wireless signal processing apparatus of claim 7, wherein the signal processing unit includes:
a front end part filtering and low noise-amplifying the transmitted and received signal; and
an amplifying part amplifying the power level of the transmitted and received signal by a predetermined gain.

10. The wireless signal processing apparatus of claim 7, wherein the matching unit includes an impedance varying part varying the impedance in accordance with the result of the comparison.

11. The wireless signal processing apparatus of claim 10, wherein the impedance varying part includes:
a first variable capacitor including one end and the other end thereof connected between a first terminal and a second terminal, between which the signal is transmitted and received, and having a capacitance varied in accordance with a first control voltage;
a second variable capacitor including one end thereof connected to the other end of the first variable capacitor and the other end thereof connected to a ground, and having a capacitance varied in accordance with a second control voltage;
a third variable capacitor including one end and the other end thereof connected between the other end of the first variable capacitor and the second terminal, and having a capacitance varied in accordance with a third control voltage;
a first inductor including one end thereof connected to the other end of the first variable capacitor and one end of the third variable capacitor and the other end thereof connected to the ground; and
a second inductor including one end thereof connected to the other end of the third variable capacitor and the other end thereof connected to the second terminal.

12. The wireless signal processing apparatus of claim 11, wherein the matching unit further includes a DAC supplying the first, second, and third control voltages to vary the capacitances of the first, second, and third variable capacitors in accordance with the control signal.
